(19) United States
(12) Patent Application Publication
(10) Pub. No.: US 2013/0073364 A1
(43) Pub. Date: Mar. 21, 2013

(54) Method of Downloading Contents

(71) Applicant: Joo-Hee Jung, Seoul (KR)

(72) Inventor: Joo-Hee Jung, Seoul (KR)

(73) Assignee: YSK MEDIA LTD., Seoul (KR)

(21) Appl. No.: 13/234,994

(22) Filed: Sep. 16, 2011

(51) Int. Cl. G06Q 30/06; G06Q 30/02; G06F 3/048

(52) U.S. Cl. 705/14.23; 715/748; 705/27.2

(57) ABSTRACT

Disclosed is a method of downloading contents corresponding to a plurality of icons displayed on a display of a terminal from a content server in the form of a package, and allowing a user to create a content-related chart to upload the created chart to the content server. The method includes: displaying, by a terminal, a plurality of first display icons downloaded from a content server storing icons corresponding to contents; displaying, by the terminal, second display icons, which remain after discarding one or more icons selected from the first display icons or replacing one or more icons selected from the first display icons with other icons; and collectively downloading, by the terminal, a plurality of contents corresponding to the second display icons, which remain after the discarding or the replacing, in the form of a package according to a download command.

### TECHNICAL FIELD

The present invention relates to a method of downloading a plurality of contents from a content server in the form of a package by a terminal, and more particularly to a method of downloading contents corresponding to a plurality of icons displayed on a display of a terminal from a content server in the form of a package, and allowing a user to create a content-related chart to upload the created chart to the content server.

### BACKGROUND ART

In recent years, the functions of mobile communication terminals such as portable terminals are becoming gradually diversified. That is, a mobile communication terminal has a data communication function as well as a voice communication function, and in particular, has a function by which the mobile communication terminal can receive various multimedia functions from a specific server. According to the diversification of functions of mobile communication terminals as described above, current internet service providers are providing download services for various multimedia contents through the wireless internet.

Meanwhile, multimedia contents may have the form of music files or dynamic picture files. Representatives of the music files include mp3 files, way files, and midi files, and representatives of dynamic picture files include MPEG2 files and MPEG4 files.

FIG. 1 is a flowchart illustrating a conventional content downloading process, which will be described hereinafter with reference to FIG. 1.

First, a mobile terminal 1 accesses a content server 2, and provides its authentication information to the content server 2. Here, the authentication information generally includes a user identifier (ID) and a password. The content server 2 authenticates the mobile terminal 1 by using the authentication information provided by the mobile terminal 1. Then, if authentication fails, the content server 2 informs the mobile terminal 1 of the authentication failure. The content server 2 requests for retransmission of authentication information from the mobile terminal 1 while informing of the authentication failure.

On the other hand, if authentication is successful, the content server 2 informs the mobile terminal 1 of the authentication success. Subsequently, if there is a request from the mobile terminal 1 for particular contents, the content server 2 downloads the particular contents to the mobile terminal 1.

The conventional process of downloading the contents from the content server as described above is inconvenient in that a user of a mobile terminal should download contents stored in a content server one by one in the conventional process. That is, in the conventional content downloading process, when a user of a mobile terminal downloads a plurality of contents from a content server, the contents should be sequentially downloaded one by one.

### SUMMARY OF THE EMBODIMENTS

Accordingly, the present invention has been made to solve the above-mentioned problems occurring in the prior art, and an aspect of the present invention provides a scheme, which enables a user of a terminal to receive a plurality of contents from a content server in the form of a package.

Another aspect of the present invention provides a scheme, which enables a user of a terminal to temporarily store icons corresponding to contents of each field to be downloaded and download the corresponding contents by using the stored icons.

The present invention also provides a scheme, which enables a user of a terminal to upload a chart created by the user to a content server.

The present invention also provides a scheme, which enables a user of a terminal to conveniently move between a plurality of fields when the user is storing icons regarding the plurality of fields.

In accordance with an aspect of the present invention, there is provided a method of downloading contents from a content server in a terminal, the method including the steps of: downloading a plurality of icons corresponding to contents from a content server and displaying the downloaded icons; deleting undesired icons, which are not required to be downloaded, from the displayed icons or replacing the undesired icons with other icons, and storing icons remaining after deletion or replacement of the undesired icons; and downloading contents corresponding to the stored icons from the content server in the form of a package.

In accordance with another aspect of the present invention, there is provided a method of displaying icons corresponding to contents by a terminal, the method including the step of: displaying a chart selection image classified into a plurality of areas in a first region of a display of the terminal; displaying, if a particular area of the displayed image is selected, a chart including a plurality of icons corresponding to the selected area in a second area of the display of the terminal; and making a drag on the display of the terminal in a predetermined direction to move the chart to a location of another chart.

In accordance with still another aspect of the present invention, there is provided a method of displaying icons corresponding to contents by a terminal, the method including the steps of: displaying a chart selection image classified into a plurality of area in a first area of a display of the terminal; displaying, if a particular area of the displayed image is selected, a chart including a plurality of icons corresponding to the selected area in a second area of the display of the terminal; and make a drag on the display of the terminal in a predetermined direction to move the displayed chart to a location of another chart.

In the method of downloading contents in the form of a package according to the present invention, a user of a portable terminal can conveniently download a plurality of contents with a single operation and can store and manage the contents to be downloaded for each field, making it possible to increase convenience for the user.

Further, a user of a portable terminal can upload a content chart for each field created by the user to a content server, allowing application developers to utilize the chart for advertising and marketing. Accordingly, the sales of application developers can be enhanced.

Furthermore, a portable terminal can receive a popular content chart for each field from a content server at a predetermined time interval or at a set time, allowing a user of the terminal to identify a popular content for each field, which is currently popular, in real time.

### BRIEF DESCRIPTION OF THE DRAWINGS

The above and other objects, features and advantages of the present invention will be more apparent from the following detailed description taken in conjunction with the accompanying drawings, in which:

FIG. 1 is a flowchart illustrating a conventional content downloading process;

FIGS. 2A to 2C are views illustrating a chart including a plurality of icons, which is displayed in a terminal according to an embodiment of the present invention;

FIGS. 3A to 3C are views illustrating a process of replacing a particular icon by another icon in a chart including a plurality of icons displayed in a terminal according to an embodiment of the present invention;

FIGS. 4A and 4B are views illustrating a process of uploading a chart created by a terminal according to an embodiment of the present invention to a content server;

FIGS. 5A and 5B are views illustrating a terminal displaying a plurality of charts according to an embodiment of the present invention;

FIGS. 6A and 6B three-dimensionally illustrate icons of a chart according to an embodiment of the present invention;

FIGS. 7A and 7B illustrate a shopping cart area and a multi-tasking area according to an embodiment of the present invention;

FIGS. 8A and 8B illustrate an example of a shifting between charts in a portable terminal capable of displaying a plurality of charts according to an embodiment of the present invention; and

FIGS. 9A and 9B illustrate chart selection images for the selection of a chart according to an embodiment of the present invention.

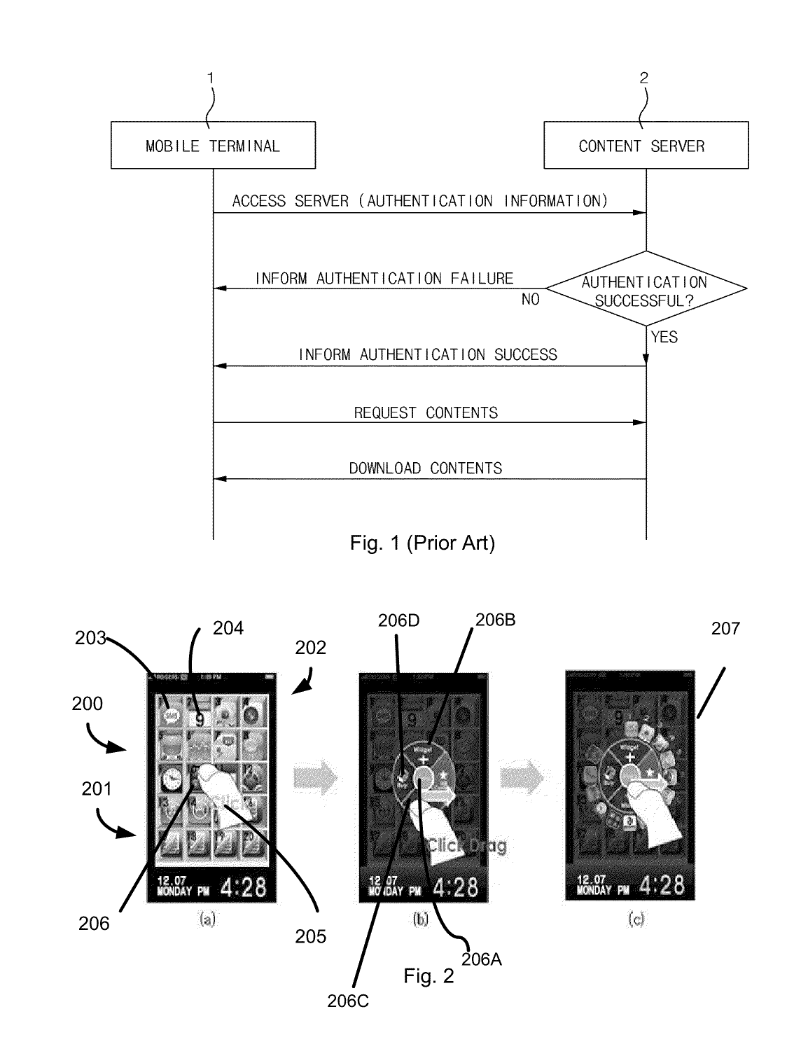

### DETAILED DESCRIPTION OF SPECIFIC EMBODIMENTS

Hereinafter, exemplary embodiments of the present invention will be described in detail with reference to the accompanying drawings so that those skilled in the art can easily understand and carry out the present invention.

The present invention proposes a scheme of requesting a content server to transmit a plurality of contents in the form of a package by a terminal and transmitting the plurality of contents requested by the terminal in the form of a package by the content server.

FIGS. 2A to 2C illustrate a process of selecting a plurality of contents to request downloading of the selected contents from a content server, by a terminal according to an embodiment of the present invention. Hereinafter, the process of selecting a plurality of contents to request downloading of the selected contents from a content server, by a terminal according to an embodiment of the present invention will be described with reference to FIGS. 2A to 2C.

In FIGS. 2A to 2C, FIG. 2A illustrates a chart (200) including a plurality of icons (201), which correspond to specific contents, respectively. Referring to FIG. 2A, twenty icons (201) may be displayed, but the number of icons displayed in the terminal (202) may vary according to a setting. That is, the number of icons (201) displayed in the terminal (202) may become different according to a setting of a user.

Referring to FIG. 2A, the terminal (202) displays an SMS message icon (203), a schedule icon (204), etc. The SMS message icon (203) corresponds to free message transmission contents or contents relating to writing, transmission, and reception of messages, and the schedule icon (204) corresponds to contents relating to making and storing of schedules. The icons (201) displayed on the terminal (202) are stored at the initial stage of purchasing the terminal (202), or are transmitted from the content server at a predetermined time interval. Generally, the icons (201) transmitted to the terminal (202) are icons corresponding to the contents whose download frequency from the content server are high or icons corresponding to the contents satisfying a standard set in advance by the user.

In addition, among the plurality of icons (201), icons corresponding to the contents whose download frequency is high may be displayed at higher positions while icons corresponding to the contents set by the user may be displayed at lower positions. That is, a plurality of icons (201) displayed on a display of the terminal may be constructed in various forms.

Referring to FIG. 2B, the user (205) drags an icon (206) in a particular shape in a state in which the user is clicking the icon (206) on the terminal. The drag shape may change according to a setting of the user. For example, the user may drag an icon in the shape of a circle, an ellipse, a straight line, a triangle, or a square. FIG. 2B illustrates a case in which the user drags an icon (206A) in a circular form. If the user drags on a display of the terminal an icon in a circular shape, a plurality of menus are displayed on the display of the terminal. FIG. 2B illustrates menus such as shopping cart, Widget + (206B), Widget − (206C), and Hit Confess (206D). FIG. 2C illustrates icons (207) displayed when a particular menu is selected from the menus of FIG. 2B.

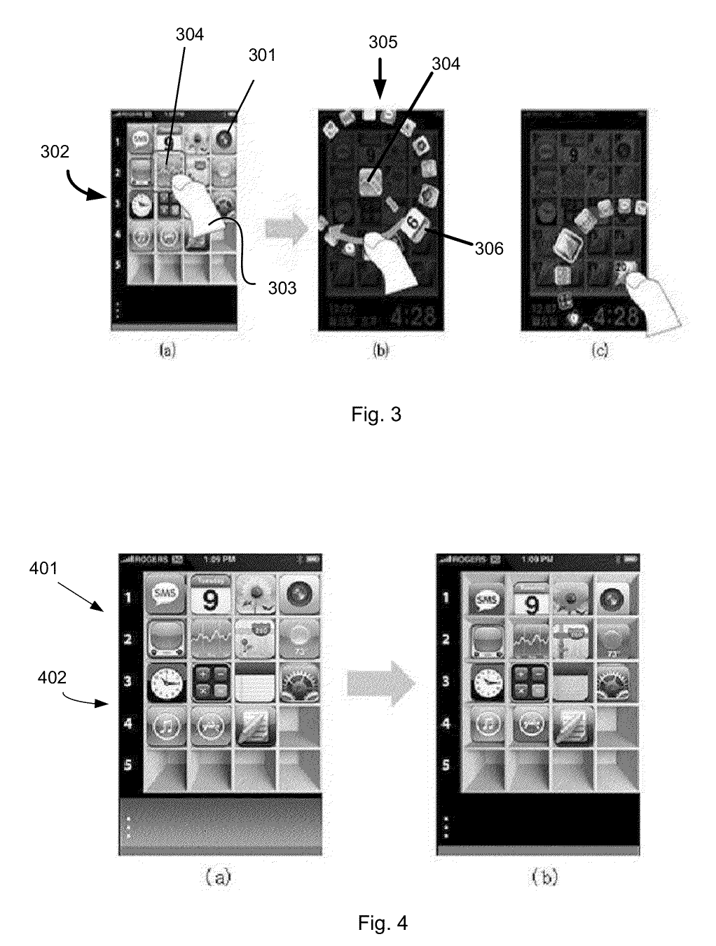

FIGS. 3A to 3C illustrate a process of replacing an icon displayed on the terminal with another icon according to an embodiment of the present invention. Hereinafter, the process of replacing an icon displayed on the terminal with another icon according to the embodiment of the present invention will be described with reference to FIGS. 3A to 3C.

FIG. 3A illustrates a plurality of icons (301) displayed on the display of the terminal (302) as illustrated in FIG. 2A. The user (303) selects one icon (304) from the plurality of icons (301) displayed on the display of the terminal.

In FIG. 3B, high-ranking icons (305), which pertain to the same genre as that of the icon (304) selected by the user, are displayed around the selected icon (304). Referring to FIG. 3B, the high-ranking icons (305) displayed on the display of the terminal (302) are displayed in a circular shape around the selected icon (304). Of course, the number and form of the high-ranking icons (305) displayed on the display of the terminal (302) may be varied by a setting.

Referring to FIG. 3B, a particular icon (306) among the high-ranking icons (305) may be displayed to be distinguished from the remaining icons. That is, the size of the particular icon (306) (the highest-ranking icon) may be made larger than the sizes of the remaining icons (305). If the user selects a particular icon (306) among the displayed high-ranking icons (305), the selected icon is moved to a location of the previously selected icon (304). When some of the high-ranking icons (305) are not displayed, the user can allow the icons which have not been displayed to be displayed by using a drag manner set in advance. Referring to FIG. 3B, if a drag is made in a certain direction around the selected icon (304), the displayed high-ranking icons (305) are also moved in the same direction. In this way, the icons which have not been displayed previously are displayed on the display of the terminal.

FIG. 3C illustrates another example of displaying the high-ranking icons (305) of the same genre around the icon selected by the user (303). The replacement and movement of the icons (305) are the same as illustrated in FIG. 3B.

As mentioned above, the present invention proposes a scheme of downloading a plurality of contents in the form of a package. In this regards, the present invention may employ a contract amount system in relation to downloaded contents. That is, a monthly fee for the sum of contents which can be downloaded each month is set to $10 dollars. In this case, if the price of each content downloaded by the user is $1 dollar, the user can download ten contents. Further, if the price of each content downloaded by the user is $2 dollars, the user can download five contents. That is, the user can freely download contents in the form of a package within the contract amount.

In addition, according to the present invention, when a plurality of contents are downloaded in the form of a package, a discount benefit may be provided to a user of the terminal. A discount benefit may be varied according to the number of downloaded contents. That is, when ten contents are downloaded in the form of a package, a discount benefit of 8% may be provided, and when twenty contents are downloaded in the form of a package, a discount benefit of 10% may be provided.

According to the present invention, it is possible to use a fixed fee system, which enables payment of a monthly fee corresponding to approximately one fifth to one fourth of the existing fee. That is, in an existing fee system, a user is allowed to download only two contents each having a price of $1 dollar. However, in the case of subscribing to a fixed fee system of $2 dollars per month, the user can download two or more contents. As an example, when the user downloads ten contents, the discount benefit enables the user to continuously use five contents, which the user wants to use, while replacing the other five contents with other contents, after one month from the downloading. Additionally, the fixed fee system may be allowed only when the sum of the monthly fees exceeds an existing fee.

It is also possible to use a service type content fixed fee system, which is a fixed fee system continuously charging a monthly service fee during the use of contents.

FIGS. 4A and 4B illustrate an open chart user interface (UI) (401) according to an embodiment of the present invention. The open chart UI allows the user of the terminal (402) to create a chart according to the taste of the user and upload the created chart to the content server. There are various genres of charts, which may be created by the user. The user may make multiple charts specific for desired genres including application, MP3, and game, or may make a single chart by integrating all genres.

A developer who has developed an application through the process can upload an application developed by himself or herself to the content server for advertising and marketing.

The content server creates and manages various types of charts for ages and themes, reflecting the number of downloads of contents and the open charts created and uploaded by the user. Table 1 illustrates an example of a chart for ages which is stored in the content server.

TABLE 1

| | Example of Open Chart UX 1.0 For Ages | | | | | | | |
|---|---|---|---|---|---|---|---|---|
| | | | | | Thirties to | | Sixties Or | |
| | Teens | | Twenties | | Fifties | | More | |
| | Male | Female | Male | Female | Male | Female | Male | Female |
| 1 | SMS | SMS | SMS | SMS | Telephone | Telephone | Hot | Hot |
| | | | | | | | Key | Key |
| 2 | SNS | Camera | Telephone | Music | SMS | SMS | Telephone | Telephone |
| | (Messenger) | | | | | | | |
| 3 | Internet | DMB | Game | Camera | Scheduler | Cosmetics | Health | Weather |
| | Phone | | | | | | information | |
| 4 | Camera | Music | Music | DMB | Navigation | Music | Weather | Health |
| | | | | | | | | Information |
| 5 | Music | Telephone | Camera | Game | Stocks | DMB | View | View |
| | | | | | | | Picture | Picture |
| 6 | Game | Bell | DMB | Telephone | Game | Bell | Navigation | Schedule |
| | | sound | | | | Sound | | |
| 7 | Telephone | Memo | Game | Calculator | Music | Memo | Schedule | D-day |
| 8 | Weather | Internet | Internet | D-day | DMB | Calculator | Game | Camera |
| | | Phone | Phone | | | | | |
| 9 | D-day | Cosmetics | D-day | Bell | D-day | Camera | D-day | Game |
| | | | | Sound | | | | |
| 10 | Memo | Calculator | Memo | Internet | Camera | Weather | Camera | Memo |
| | | | | Phone | | | | |
| 11 | Calculator | D-day | Calculator | Memo | Internet | D-day | Calculator | Navigation |
| | | | | | Service | | | |
| 12 | Telecom | Telecom | Telecom | Telecom | Telecom | Telecom | Telecom | Calculator |
| | Service | Service | Service | Service | Service | Service | Service | |
| 13 | Embedded | Embedded | Embedded | Embedded | Embedded | Embedded | Embedded | Embedded |
| | memory | memory | memory | memory | memory | memory | memory | memory |
| 14 | Alarm | Alarm | Alarm | Alarm | Alarm | Alarm | Alarm | Alarm |
| 15 | Electronic | Electronic | Electronic | Electronic | Electronic | Electronic | Electronic | Electronic |
| | Dictionary | Dictionary | Dictionary | Dictionary | Dictionary | Dictionary | Dictionary | Dictionary |
| 16 | Local | Local | Local | Local | Local | Local | Local | Local |
| | Time | Time | Time | Time | Time | Time | Time | Time |
| 17 | Stop | Stop | Stop | Stop | Stop | Stop | Stop | Stop |
| | Watch | Watch | Watch | Watch | Watch | Watch | Watch | Watch |
| 18 | Background | Background | Background | Background | Background | Background | Background | Background |
| | Lighting | Lighting | Lighting | Lighting | Lighting | Lighting | Lighting | Lighting |
| 19 | Font | Font | Font | Font | Font | Font | Font | Font |
| 20 | Sound | Sound | Sound | Sound | Sound | Sound | Sound | Sound |
| | Effect | Effect | Effect | Effect | Effect | Effect | Effect | Effect |

Referring to Table 1, the content server stores a chart, which includes contents arranged based on the gender according to the age. For example, it is noted from Table 1 that the favorite content of male and female users in their teens and twenties is SMS, and the favorite content of males and females in their thirties to fifties is typical phone, and the favorite content of males and females in their sixties or more is hot key.

Table 2 illustrates an example of a chart including contents according to themes, which is stored in the content server.

TABLE 2

| | For Themes (Males In Their Thirties) | | | |
|---|---|---|---|---|
| | Music Fan | Movie Fan | Sports Fan | Game Fan |
| 1 | Punk Music | Action Movie | Football | MMORGP |
| 2 | Hip-hop Music | Romantic | Baseball | Shooting Game |
| | | Comedy | | |
| 3 | Rock Music | Cult Movie | Tennis | Puzzle |
| 4 | Hard Rock | Erotic Movie | Swimming | Action |
| | Music | | | |
| 5 | Soft Rock | Thriller | Cycling | Online Game |
| | Music | | | |
| 6 | New Metal | Horror Movie | Basketball | Sports |
| | Music | | | |
| 7 | New Age Music | Drama | Baseball | Infant Game |
| 8 | Twist Music | Comedy | Golf | Casual Game |
| 9 | Classic Music | Chivalry | Horse Racing | One Button |
| | | Movie | | Game |
| 10 | DJ Music | Science | Rugby | Arcade Game |
| | | Fiction movie | | |
| 11 | Drum & Bass | Classic Movie | American | Simulation |
| | Music | | Football | Game |
| 12 | Electronic | Humanism | Volleyball | Adventure |
| | Music | Movie | | Game |
| 13 | Pop Music | Children | Wrestling | Board Game |
| | | Movie | | |
| 14 | Punk Music | Documentary | Judo | Aircraft |
| | | Movie | | Simulation |
| | | | | Game |
| 15 | Jazz Music | Independent | Taekwondo | RPG |
| | | Movie | | |
| 16 | R & B Music | Christmas | Bowling | Racing Game |
| | | Movie | | |
| 17 | Rock N Roll | War Movie | Yacht Racing | Scenario Game |
| | Music | | | |
| 18 | Soul Music | Silent Film | Motor Racing | Management |
| | | | | Strategy Game |
| 20 | Rap Music | Foreign Movie | Survival Game | Intelligence |
| | | | | Developing |
| | | | | Game |

Referring to Table 2, the content server stores a chart for males in their thirties, which includes contents according to themes. For example, it is noted that the favorite content of music fans is punk music, the favorite content of movie fans is an action movie, the favorite content of sports fans is football, and the favorite content of game fans is MMORGP.

The content server may create and store a chart based on continents or religions in addition to the charts based on the ages and themes. Table 3 illustrates an example of a chart including contents according to continents, which is stored in the content server.

TABLE 3
For Continents (Males In Their Thirties)

| | | Central and | | | |
|---|---|---|---|---|---|
| | North America | South America | Asia (China) | Japan | Europe |
| 1 | Sports | Sports | Entertainment | Otaku Special | Sports |
| 2 | Business | Entertainment | Life Style | Sports | Entertainment |
| 3 | Entertainment | Business | Business | Entertainment | Life Style |
| 4 | Education | Life Style | Sports | Animation | Business |
| 5 | Finance | Music | Music | Life Style | Music |
| 6 | Life Style | News | Finance | Map | Social |
| | | | | | Network |
| 7 | Music | Education | Social | Utility | Travel |
| | | | Network | | |
| 8 | News | Finance | News | Travel | Utility |
| 9 | Social | Social | Health | Utility | Weather |
| | Network | Network | | | |
| 10 | Travel | Travel | Picture | Weather | News |
| 11 | Utility | Utility | Books | Business | Education |
| 12 | Weather | Weather | Weather | Music | Finance |
| 13 | Health | Navigation | Education | Social | Book |
| | | | | Network | |
| 14 | Picture | Local Time | Travel | Education | Map |
| 15 | Utility | Health | Utility | Finance | Utility |
| 16 | Medical | Picture | Navigation | Book | Medical |
| 17 | Navigation | Books | Map | Medical | Navigation |
| 18 | Book | Map | Utility | Navigation | Local Time |
| 20 | Local Time | Medical | Local Time | Local Time | Picture |

Referring to Table 3, the content server stores a chart for males in their thirties, which includes contents based on the continents. For example, it is noted that the favorite content of North American males is sports, the favorite content of Central and South American males is sports, the favorite content of Asian (Chinese) males is entertainment, the favorite content of Japanese males is otaku special, and the favorite content of European males is sports.

Hereinafter, a process of accessing a site managing a content server and downloading contents in the form of a package using a terminal by a user will be described.

The user accesses the site managing the content server by using the terminal. The user inputs a field of desired contents to the accessed site. For example, “a teenager who likes games”, “a male in his twenties who likes sports”, and “a female in her thirties who likes shopping” may be input as fields input by the user.

If the user inputs the field of contents, the corresponding site displays icons related to the field of contents input by the user on a display of the terminal. The user may replace some of the icons displayed on the terminal as described above with reference to FIG. 2, or selects and purchases corresponding icons to download them. Of course, the user may purchase or discard the selected icons after storing them in a separate shopping cart. As described above, the number and types of the icons displayed on the display of the terminal may be various according to a setting.

Hereinafter, a process in which a user accesses a site managing the content server by using the terminal and uploads an open chart created by the user, will be described.

The user accesses the site managing the content server by using the terminal. The user inputs a field for uploading the open chart created by himself or herself to the accessed site. For example, “a teenager who likes games”, “a male in his twenties who likes sports”, and “a female in her thirties who likes shopping” may be input as fields input by the user.

The user inputs the field to be uploaded and uploads the open chart to the content server. The content server updates the already stored charts by using the open chart uploaded by the user. By repeating this process, the content server can create and store various charts capable of satisfying the taste of the user.

As mentioned above, the user downloads contents or uploads a chart by using a terminal, but the present invention is not limited thereto. That is, the user can download or upload contents using a PC or other communication devices.

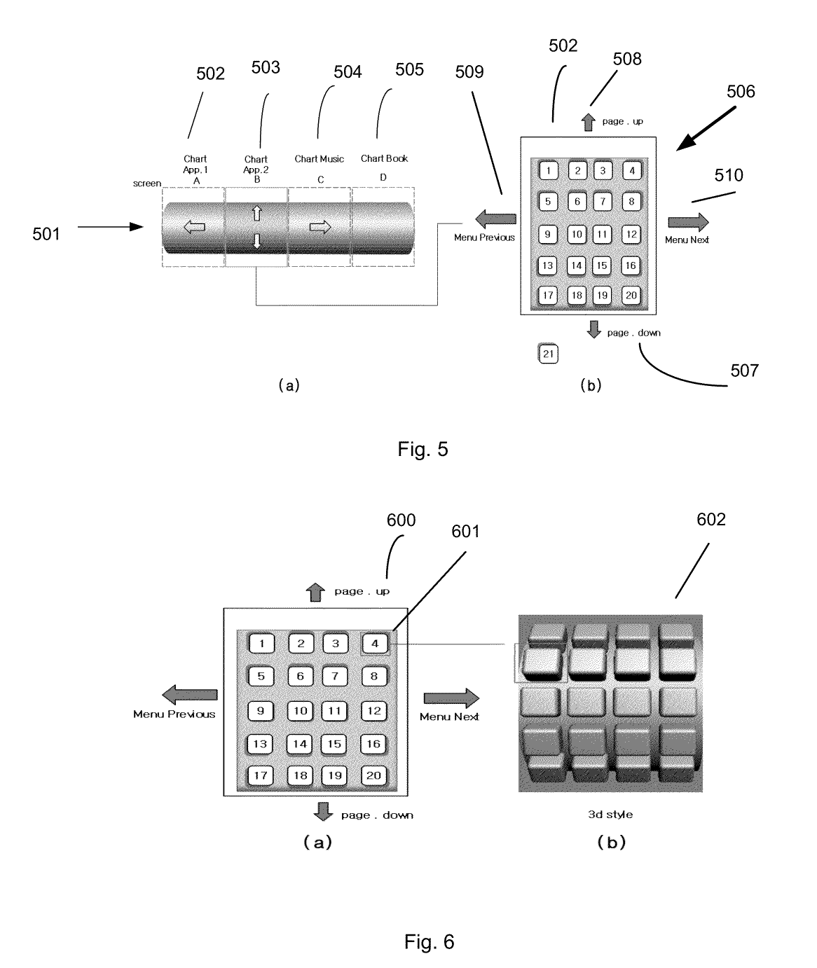

A scheme of displaying one chart on the display of the terminal has been described with reference to FIGS. 2 to 4. Hereinafter, a method of displaying a plurality of charts on a display of a terminal will be described with reference to FIGS. 5A to 9B.

FIGS. 5A and 5B illustrate an example of displaying a plurality of charts on a display of a terminal according to an embodiment of the present invention. Hereinafter, a method of displaying a plurality of charts on a display of a terminal according to the embodiment of the present invention will be described with reference to FIGS. 5A and 5B.

Referring to FIGS. 5A and 5B, the display of the terminal (501) displays four charts. Of course, the number and types of the charts displayed on the display of the terminal may change according to a setting. FIG. 5A illustrates a first application chart (Chart App 1) (502), a second application chart (Chart App 2) (503), a music chart (Chart Music) (504), and a book chart (Chart Book) (505). If a user selects a particular chart among the four charts, detailed information regarding the corresponding chart is displayed as shown in FIG. 5B. FIG. 5B illustrates twenty high-ranking icons (506) of the second application chart (Chart App 2) (503), which is displayed when the user has selected the second application chart (Chart App 2) (503). Of course, the user may allow icons corresponding to other ranks to be displayed by selecting and using “page. down” (507) or “page. up” (508). For example, if the “page. down” (507) is selected, icons corresponding to ranks 21 to 40 of the second application chart (Chart App 2) (503) are displayed. The “page. down” (507) or “page. up” (508) may be selected by the user, by selecting a corresponding mark displayed on the display of the terminal or making a drag on the display along a specific direction.

Referring to FIG. 5B, if the user makes a drag on the display leftward (509), the first application chart (Chart App 1) (502) is displayed. In contrast, if the user drags the display rightward (510), the music chart (Chart Music) (504) is displayed. Of course, in case of movement to a particular chart, icons having the same rank as the rank currently displayed on the display or the top twenty high-ranking icons may be displayed.

FIGS. 6A and 6B illustrate an example (600) of displaying icons (601) not in a two-dimensional plane but three-dimensionally (602). As illustrated in FIGS. 6A and 6B, icons may be displayed three dimensionally according to a setting, as well as in the form of a plane.

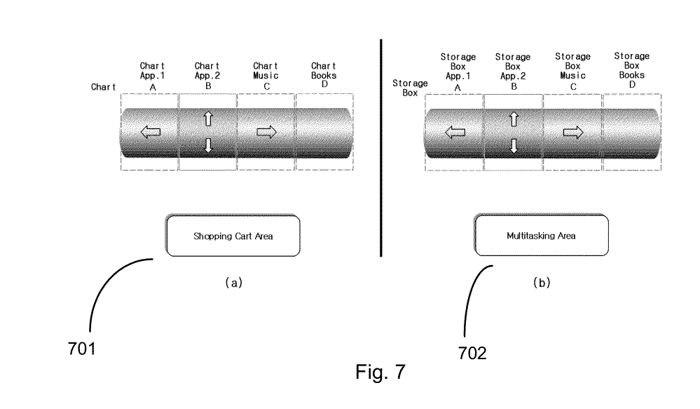

FIGS. 7A and 7B illustrate a shopping cart area and a multi-tasking area according to an embodiment of the present invention.

As illustrated in FIG. 7A, the shopping cart area (701) is an area where icons (corresponding to contents) are temporarily stored to allow the user of the terminal to purchase items according to each field. As illustrated in FIG. 7B, the multi-tasking area (702) refers to an area in which a content corresponding to a corresponding icon downloaded by the user of the terminal is stored.

As mentioned above, according to the present invention, the shopping cart area (701) for temporarily storing icons to be downloaded is distinguished from the multi-tasking area (702) for storing a downloaded content. That is, the content downloaded from the content server by the user is moved to and stored in a corresponding storage box in the multi-tasking area.

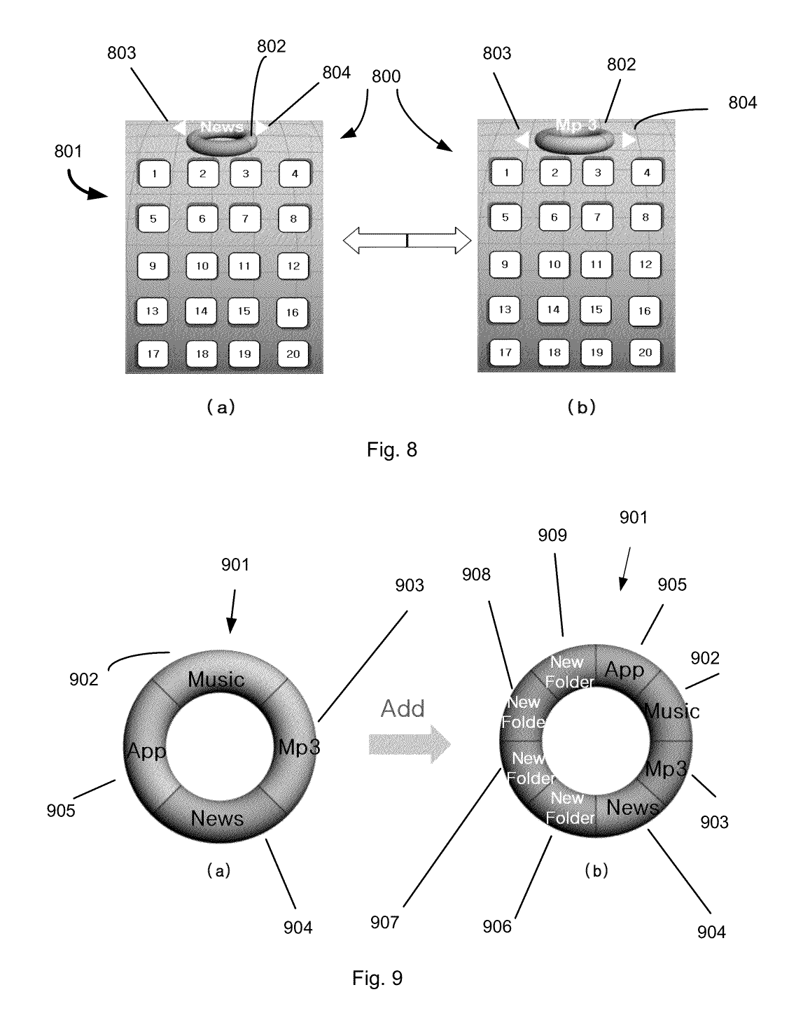

FIGS. 8A and 8B illustrate another example of a plurality of charts (800) displayed by a terminal (801) according to an embodiment of the present invention. Referring to FIGS. 8A and 8B, a ring-shaped user interface (UI) (802) which is classified into a plurality of areas is displayed at an upper part of the display. Each of the classified areas is associated with a specific field of the shopping cart area or the multi-tasking area.

FIG. 8A illustrates an icon or a content regarding a news area, and FIG. 8B illustrates an icon or a content regarding an MP3 area. The shift between the news area and the MP3 area can be achieved by the user, by using movement bars ( [symbol] (803) and [symbol] (804) displayed at an upper end of the display, or by selecting a part displaying a corresponding area of the ring-shaped UI displayed on the display.

FIGS. 9A and 9B illustrate another example of a ring-shaped UI displayed on a display of a terminal, which includes a plurality of charts. Referring to FIG. 9A, the ring-shaped UI (901) is classified into fields of music (Music) (902), MP3 (Mp3) (903), news (News) (904), and application (App) (905). Of course, as mentioned above, the ring-shaped UI (901) may be divided into and operated with various numbers of areas, instead of the four areas. For example, it may be divided into and operated with eight areas as illustrated in FIG. 9B (902-909) such that each of the eight areas may have a specific color or shape according to the field.

Although the present invention has been described as an example of a terminal, it is not limited thereto. That is, the present invention can be applied to devices in conjunction with wired/wireless networks such as a TV/internet TV, a set-top box, an e-book, a laptop computer, and a WIFI device.

Although exemplary embodiments of the present invention have been described for illustrative purposes, those skilled in the art will appreciate that various modifications, additions and substitutions are possible, without departing from the scope and spirit of the invention as disclosed in the accompanying claims.

The embodiments of the invention described above are intended to be merely exemplary; numerous variations and modifications will be apparent to those skilled in the art. All such variations and modifications are intended to be within the scope of the present invention as defined in any appended claims.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

What is claimed is:

1. A method of downloading contents from a content server by a terminal, the method comprising:
displaying, by a terminal, a plurality of first display icons downloaded from a content server storing icons corresponding to contents;
displaying, by the terminal, second display icons, which remain after discarding one or more icons selected from the first display icons or replacing one or more icons selected from the first display icons with other icons; and
collectively downloading, by the terminal, a plurality of contents corresponding to the second display icons, which remain after the discarding or the replacing, in a form of a package according to a download command.

2. The method as claimed in claim 1, wherein the content server transmits an icon corresponding to at least one download condition, which includes an age, a job, or a field and is set by the terminal, to the terminal.

3. The method as claimed in claim 2, wherein the download condition set by the terminal comprises at least one of an age, a job, and a field.

4. The method as claimed in claim 1, wherein the replacing one or more icons selected from the first display icons with other icons comprises:
selecting an icon to be replaced from the first display icons;
displaying, around the selected icon, at least two icons corresponding to contents belonging to a genre identical to that of the selected icon; and
exchanging a location of the selected icon with a location of a replacement icon, which is selected from the at least two icons displayed around the selected icon.

5. The method as claimed in claim 1, wherein the content server compares a contract amount of money agreed for the terminal with a fee for the plurality of contents corresponding to the second display icons to be downloaded, and transmits the plurality of contents in the form of the package if the contract amount of money is not less than the fee.

6. The method as claimed in claim 5, wherein a user of the terminal is given a discount benefit, which varies according to the number of contents downloaded in the form of the package.

7. The method as claimed in claim 5, wherein the contract amount is charged monthly and is based on a fixed fee system including a discount benefit.
